(19) United States
(12) Patent Application Publication
(10) Pub. No.: US 2005/0288960 A1
(43) Pub. Date: Dec. 29, 2005

(54) Resource management system

(76) Inventor: Shawn T. Sharp, Austin, TX (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/159,460

(22) Filed: Jun. 23, 2005

Related U.S. Application Data
(60) Provisional application No. 60/582,408, filed on Jun. 24, 2004.
(60) Provisional application No. 60/586,398, filed on Jul. 8, 2004.

(51) Int. Cl. G06F 17/60

(52) U.S. Cl. 705/1; 705/400

(57) ABSTRACT

This disclosure is concerned with systems, methods and devices for managing consumption of a resource, such as water, gas or electricity for example, by one or more resource-using devices. In one example of a method for managing usage of a resource by a resource-using device, resource cost information representing a per unit cost of a resource is obtained and stored. Then, the amount of the resource used by the resource-using device over a predetermined period of time is measured. The cost information and the resource consumption is then used to calculate a resource consumption cost associated with the resource-using device. Finally, output is provided to a user, where the output represents the calculated resource consumption cost.

### RELATED APPLICATIONS

This application claims the benefit of: U.S. Provisional Patent Application Ser. No. 60/582,408, entitled RESOURCE USAGE MANAGEMENT SYSTEM, filed Jun. 24, 2004; and, U.S. Provisional Patent Application Ser. No. 60/586,398, entitled RESOURCE USAGE MANAGEMENT SYSTEM, filed Jul. 8, 2004. All of the aforementioned patent applications are incorporated herein in their respective entireties by this reference.

### BACKGROUND OF THE INVENTION

1. Field of the Invention

This invention relates generally to tracking and management of the use of consumable resources. More particularly, exemplary embodiments of the invention are concerned with monitoring and metering systems and devices that provide real-time feedback about resource usage, cost, and related considerations.

2. Related Technology

In light of considerations such as escalating utility costs, and environmental concerns pertaining to the consumption of resources, utility users are under pressure to accurately track and account for utility usage. Unfortunately, users are not able to know, or constantly monitor how much of a utility is used by a specific device. This problem is a matter of concern for all utility users, but is of particular concern where the utility consumption levels are large, such as in industrial applications. In the past, it has not been possible for a user to easily find out how much of a utility a specific devices uses. Some devices have a usage or load rating, but this value is usually only accurate under specific usage conditions and still does not provide information on variety of load conditions.

Oftentimes, the user lacks the ability to individually monitor multiple devices operating at the same time. Since all utility outlets at a location are typically connected to a single meter, it is impractical for a user to know how much of that utility their device is using. Thus, the only way for a user to accurately and reliably determine the amount of a utility that a specific devices uses is to disconnect all other devices from the utility to be measured, such as electricity, water, or natural gas for example, at a location and then monitor the location meter used by the utility company. Obviously, this sort of approach is problematic, particularly for industrial users that may have a multitude of different types of resource consuming systems and devices.

Another concern is that typical measurement and tracking systems and devices are not well-suited to provide real-time, or substantially real-time, feedback about the cost of the utility used by the device or devices. Thus, it is quite difficult, if not impossible, for a user to quickly and reliably determine how much the use of the device is costing. Even if the user could determine total or average usage information, as in the utility meter example outlined above, it would be impossible to determine or calculate the real-time or accumulated usage cost for a specific device. Because of the difficulty of determining the usage cost for a specific device, most users do not bother with the exercise and the net result is often a waste of utility resources. While this result may not be of great concern on smaller scales, such as in the case of a very inefficient refrigerator in the garage of a resident, this result is of significant concern to large users with multiple resource consuming devices, since even small utility wastage at each device can result in a large aggregate loss.

### BRIEF SUMMARY OF AN EXEMPLARY EMBODIMENT OF THE INVENTION

In view of the foregoing, and other, problems in the art, what is needed are systems, methods and devices that permit users to track and manage resource usage at each of a plurality of different resource consuming devices.

In one exemplary embodiment of the invention, a resource meter is provided that includes a measurement module configured to measure an amount of resource used by one or more resource-using devices, and configured to display the amount of resource used the monitored devices. The exemplary resource meter also includes a resource distribution module that is able to regulate resource usage of by the resource-using devices. Such regulation can be performed based on a variety of different variables and criteria, such as a measured amount of resource used by the resource-using device. Yet other exemplary embodiments of the invention are concerned with systems and methods for tracking and managing resource usage at one or more different resource consuming devices

The foregoing, and other, aspects of exemplary embodiments of the invention will become more fully apparent from the following description and appended claims.

### BRIEF DESCRIPTION OF THE DRAWINGS

To further clarify the above and other aspects of exemplary embodiments of the invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a block diagram indicating various aspects of an exemplary embodiment of a resource management system;

FIG. 1B is a block diagram indicating further aspects of the exemplary resource management system shown in FIG. 1A;

FIG. 1C is a schematic of an exemplary resource meter;

FIG. 2 is a flowchart illustrating aspects of an exemplary method for tracking resource usage and capturing associated consumption costs;

FIG. 3 is a flowchart illustrating aspects of an exemplary method for tracking and managing resource usage;

FIG. 4 is a block diagram of an exemplary operating environment for systems, methods and devices of the present invention; and

FIG. 5 is a flowchart illustrating aspects of an exemplary method for tracking and managing resource usage, as well as performing related processes such as billing.

### DETAILED DESCRIPTION OF SOME EXEMPLARY EMBODIMENTS

Exemplary embodiments of the invention are concerned with systems, methods and devices for measuring and managing resource usage by one or more resource-consuming devices. The principles of the present invention, however, are not limited to measuring and management of resource usage. Rather, the systems and methods disclosed herein can be successfully used for any other suitable purposes and in connection with other types of systems and methods.

As used herein, “resource” is a broad term and is used in its ordinary meaning and includes, but is not limited to energy, such as, electricity and natural gas for example, water, steam, gasoline, cable television, satellite television, bandwidth, telecommunications, radio, short distance telephone service, long distance telephone service, Internet service, mobile telephone service, electrical or optical digital data service, satellite service, and any other materials consistent with embodiments of the invention. Indeed, if desired, embodiments of the present invention may be adapted for any other resource that may be used, measured, and/or distributed.

While the invention extends to a variety of resources and methods for measuring the cost of usage of such resources, the invention is particularly applicable to the measurement of electrical power usage by electrical appliances and the calculation of the cost of operation of such electrical appliances. According to one embodiment of the invention, the resource management system is a portable power meter that can be connected to an electrical appliance to measure the amount of electricity used by the electrical appliance over a specified period of time. That information, combined with information specifying the per-unit cost of electricity, can be used by the measurement system to calculate the cost of using the appliance. In this manner, consumers and others who use the measurement system can temporarily connect electrical appliances, such as refrigerators, freezers, consumer electronics equipment, etc., to the measurement system to find out how much electricity is consumed by the appliances and how much it costs to operate the appliances. This information is useful because it informs the consumer of the ongoing cost of operating electrical appliances.

I. Exemplary Resource Management Systems

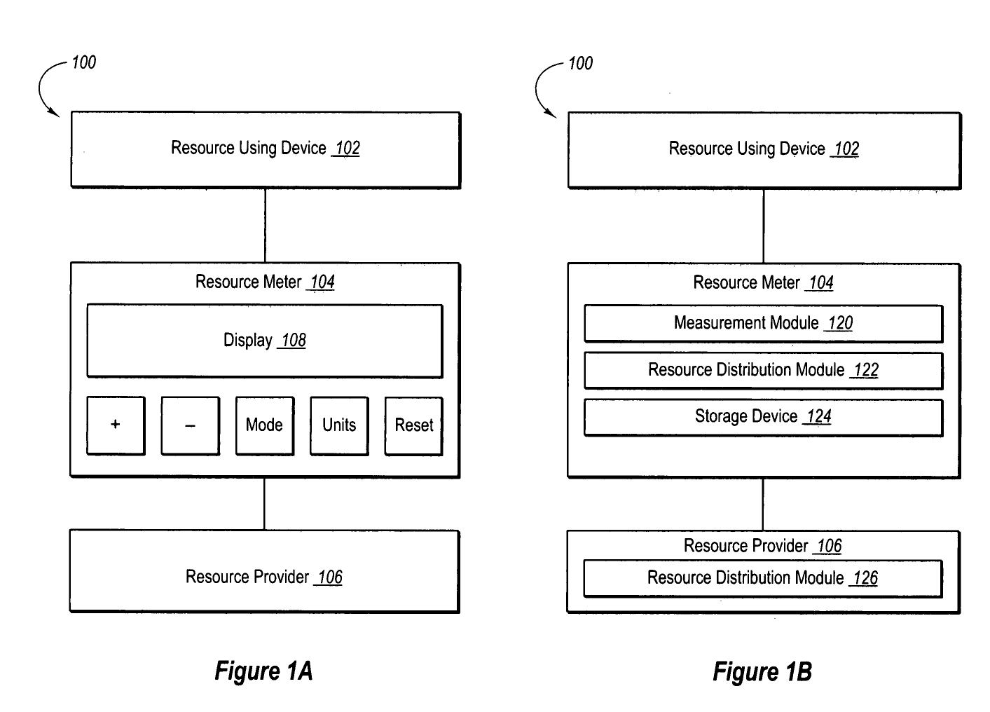

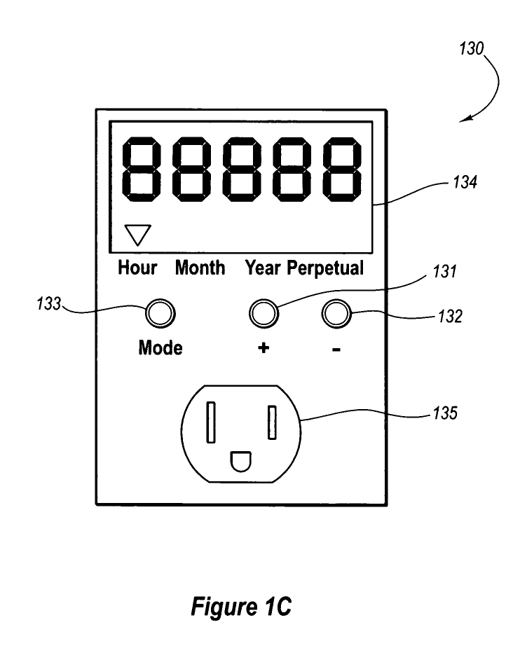

With attention now to FIG. 1A, details are provided concerning an exemplary embodiment of a resource management system 100. The resource management system 100 may include one or more resource using devices, such as resource using device 102, one or more resource meters, such as resource meter 104, one or more resource providers, such as a resource provider 106, any suitable combination thereof, and any other suitable components. In one embodiment, the resource meter 104 may comprise resource meter or the like. The resource meter 104 may comprise one or more hardware modules, one or more software modules, or both. The resource meter 104 may comprise one or more suitable computing devices. Further details concerning an exemplary resource meter are provided in connection with the discussion of FIG. 1C below.

The resource using device 102 may comprise a device adapted to access, consume, and/or otherwise use a resource. Exemplary devices adapted to use electricity may include refrigerators, freezers, HVAC systems, microwave ovens, computers, televisions, lights, lighting systems, stereos, VCRs, DVD players, other audio visual equipment, computing devices, and the like. Exemplary devices adapted to use water may include a sink, a dishwasher, a washing machine, a toilet, a sprinkler system, a pool, and a refrigerator ice maker. Exemplary devices adapted to use natural gas may include gas heaters, air heaters, water heaters, stoves, ovens, clothes dryers, fireplaces, barbecues, and the like. Of course, the resource using device 102 may comprise any other device that may use, access, and/or consume electricity, water, natural gas, or any other resource depending upon, for example, the intended use of the resource management system 100.

In one embodiment, the resource provider 106 may comprise a device adapted to distribute a resource. For example, the resource provider 106 may comprise a receptacle, such as, an electrical outlet that may be connected to a power supply and that may include a socket for a plug. Also, as an example, the resource provider 106 may comprise a conduit or a portion thereof through which a resource may be distributed. Of course, the resource provider 106 may comprise any other suitable devices or distribution systems and components that may be used to distribute or otherwise make a resource available to one or more users.

As shown in FIG. 1A, the resource meter 104 may be configured to be connected to one or more resource using devices, such as the resource using device 102, to one or more resource providers, such as the resource provider 106, or both. The resource using device 102 could be configured to connect to the resource provider 106. In one embodiment, the resource meter 104 may advantageously be portable and may also be configured to be removably connected, or otherwise coupled, to one or more resource using devices, to one or more resource providers, or both. Of course, the resource meter 104 need not be portable and need not be connected or coupled in any manner to any resource using device or any resource provider.

In some instances, a person may desire to discover the amount of resource usage and/or the cost of that resource usage for one or more resource using devices. In one embodiment, the resource meter 104 may advantageously be configured to monitor resource usage, to display resource usage, to monitor the cost of the resource usage, to display the cost of the resource usage, to perform any desired combination thereof, and/or to perform any other desired function. For example, upon purchasing a new refrigerator for a kitchen, a person could choose to move the old refrigerator into a garage to provide supplemental cold storage. Because older refrigerators tend to use more electricity, the person may use the resource meter 104 to discover the amount of electricity that the old refrigerator uses and/or the cost of that electricity used. Advantageously, the person may then decide whether the supplemental cold storage is worth the added electrical cost.

In one embodiment, the resource meter 104 may be configured to display information. For example, as shown in FIG. 1A, the resource meter 104 may include a display 108, which may comprise an LCD display, a computer monitor, or any other suitable display. The display 108 may be configured to display resource usage, to display the cost of the resource usage, both resource usage and cost, and/or to display any other suitable data. The display 108 could be assembled integrally with the resource meter 104, but the display 108 could be assembled as a separate component to the resource meter 104, if desired.

The resource meter 104 may be configured to receive user input. For example, as shown in FIG. 1A, the resource meter may include a plus button 110, a minus button 112, a mode button 114, a units button 116, and a reset button 118. Of course, the resource meter 104 could receive user input using different buttons, fewer buttons, or more buttons. Also, some embodiments of the resource meter 104 receive user input using another suitable input device, including but not limited to keypads, keyboards, mice, force-sensitive screens, such as touch-sensitive screens, and pen-sensitive screens for example, as well as voice-sensitive inputs. Further, it will be appreciated that the resource meter 104 need not be configured to receive user input, depending upon, for example, the intended use of the resource meter 104.

With continuing attention to FIG. 1A, and directing attention now to FIG. 1B as well, additional details are provided concerning an exemplary resource management system 100. As illustrated in FIG. 1B, the resource meter 104 may include a measurement module 120, a resource distribution module 122, and a storage device 124, which may comprise one or more storage devices. As used herein, “storage device” is a broad term and is used in its ordinary meaning and includes, but is not limited to, a hard disk drive, a tape drive, a redundant array of independent disks (RAID), a removable storage disk, a non-removable storage disk, a floppy disk, a CD-ROM or other optical disk, magnetic disk storage, memory, flash memory, nonvolatile memory, volatile memory, random access memory (RAM), RAM cache, RAM made using complementary metal oxide semiconductor technology (CMOS RAM), read-only memory (ROM), programmable read-only memory (PROM), erasable programmable read-only memory (EPROM), electrically erasable programmable read-only memory (EEPROM), any other suitable computer-readable medium, any combination thereof, and the like. As shown in FIG. 1B, the resource provider 106 may include a resource distribution module 126.

II. An Exemplary Resource Meter

As noted elsewhere herein, some exemplary embodiments of the invention are directed to resource meters and associated hardware and software. With attention now to FIG. 1C, details are provided concerning one exemplary resource meter, denoted generally at 130.

The illustrated resource meter 130 includes a four button primary user input interface that includes a + button 131, a − button 132, and a mode button 133. Additionally, the resource meter 130 includes a large, easy to read display 134, such as an LCD screen, and an integrated Ground Fault Interrupter (GFI) circuit 135 and switches. Finally, at least some embodiments of the resource meter 130 include a master reset button (not shown) that permits a user to erase any usage data or utility cost information. It should be noted that the resource meter 130 is generally configured in a manner consistent with the resource that is to be monitored and measured. Thus, exemplary embodiments of the resource meter include one or more suitable resource interfaces (not shown) such as probes, transducers, jumpers and/or other connections and interfaces that enable measurement, tracking and other operations concerning the resource. In some embodiments, the resource meter 130 also includes a provider interface (not shown) configured to connect with a resource provider system or device.

Devices such as the resource meter 130 are configured to perform a variety of useful functions. One example of such a function is the ability to input utility cost. Particularly, using the + button 131 and the − button 132, users are able to set a specific cost per utility cost for their location; cost per kilowatt hour for the electric monitor, cost per gallon for the water meter, cost per therm for the gas meter. Various embodiments of the invention permit either a single average cost to be used or allow for multiple cost numbers to be input in conjunction with different volume thresholds. Users can obtain this information from their utility company or from a current billing statement.

The exemplary resource meter 130 also provides the ability to store the utility cost. According to one embodiment of the invention, the resource meter 130 stores the cost information input by the user in non-volatile memory, which means that the cost information will remain intact even after the resource meter 130 has been disconnected from the resource being measure, such as electricity for example. The purpose for storing this information is to keep the user from having to input the information each time the resource meter 130 is used.

Yet another useful aspect of exemplary resource meter 130 is the ability to store usage data. Particularly, the resource meter 130 uses stored measurement data from the moment the resource meter 130 is connected until the moment the resource meter 130 is disconnected. The resource meter 130 constantly measures the flow of whatever is being measured and stores that information in memory. The resource meter 130 can also simultaneously store the amount of time the resource meter 130 has been connected in measurement mode. The amount of data stored can vary based on the amount of available memory in the resource meter 130.

The exemplary resource meter 130 also has the ability to calculate usage cost over different time periods. The device can calculate the estimated utility cost for the utility service being measured on various bases, including, per hour, per month, per year, perpetual, or on another basis.

With reference now to particular elements of the exemplary resource meter 130, the four button primary user input system can be used in various ways. Thus, the + button 131 can be used in set mode, hour, month, year or perpetual mode, while the − button 132 can be used in set mode, in hour, month, year or perpetual mode. The mode button 133 can be used in set mode, in hour mode, in month mode, in year mode, and in perpetual mode. Additionally, a units button (not shown) can be employed in set mode, as well as in hour, month, year or perpetual mode.

Exemplary embodiments of the resource meter 130 are also quite flexible in terms of connectivity. For example, the resource meter 130 can communicate back to a centralized computing node via one or more of a 10/100/1000 Ethernet network, wireless network, power line network, or any other network or communication platform with enough bandwidth and adequate latency. Such networking connections can be used to, among other things, communicate usage and/or cost data, perform remote monitoring and/or shutdown of devices based on usage, cost, volume, load (local, or all devices), and time of day (specific times, or relative to preferred loading times).

As the foregoing suggests, the resource meter 130 can be usefully employed in a variety of different ways and in different environments. For example, the resource meter 130 enables service providers such as utility companies, resellers, and local businesses, to charge customers for actual usage of a utility without requiring installation of separate, fixed external meters. Some particular examples include electricity metering example for service providers such as hotels, storage units, and airplanes.

The resource meter 130 can also communicate usage data to service providers through any of the networking connections, as well as use smart-card/sim-card technology to enable power usage at a public or rented locations. One implementation option requires custom plug receptacles that would only allow utility to flow if a valid smart-card enable monitor/meter was used. Some smart-card electricity monitoring examples include public libraries, airports, hotels, parks, and RV parks. Some smart-card water monitoring examples include RV parks, parks, and hotels.

The resource meter 130 is not limited to passive functions such as monitoring however. For example, some embodiments of the resource meter 130 have the ability to switch the flow of the utility on or off based on usage information, such as volume and/or cost. In an electricity switching example, the resource meter 130 turns air conditioning off after usage has reached a specific amount per hour, per day, per month, or perpetual. In a water switching example, the resource meter 130 turns sprinklers off after usage has reached a specific amount per hour, per day, per month, or perpetual. In a natural gas switching example, the resource meter 130 can turn a gas fireplace off after usage has reached a specific amount per hour, per day, per month, or perpetual.

In connection with the foregoing examples of active functions of the resource meter 130, it is further noted that the resource meter 130 is configured for localized connectivity to a computer to enable a smart shutdown process for the computer (i.e. as the computer is approaching the preset shutdown level, send a soft shutdown command to the computer before switching off the power.

Additionally, the resource meter 130 provides the ability to input tiered utility cost data and calculate usage based on those tiers, as well as the ability to expand the memory capacity via external media, such as a USB memory stick for example. The resource meter 130 also has the ability to transfer usage, cost and other data from internal memory to external media.

In yet other implementations, the resource meter 130 is configured to be integrated within the resource user whose usage is to be monitored and/or controlled. Some integrated electricity monitoring examples include, but are not limited to, refrigerators and freezers, HVAC systems, microwave ovens, computers, televisions, lights or lighting systems, circuit breakers, entire premises, other audio visual equipment. Along the same lines some integrated water monitoring examples include, but are not limited to, sprinkler systems, sinks, baths, washing machines, and pools. Finally, some integrated natural gas monitoring examples include, but are not limited to, entire premises, gas heaters, air heaters, water heaters, stoves, clothes dryers, fireplaces, and gas barbeques.

III. Exemplary Resource Tracking and Management Methods

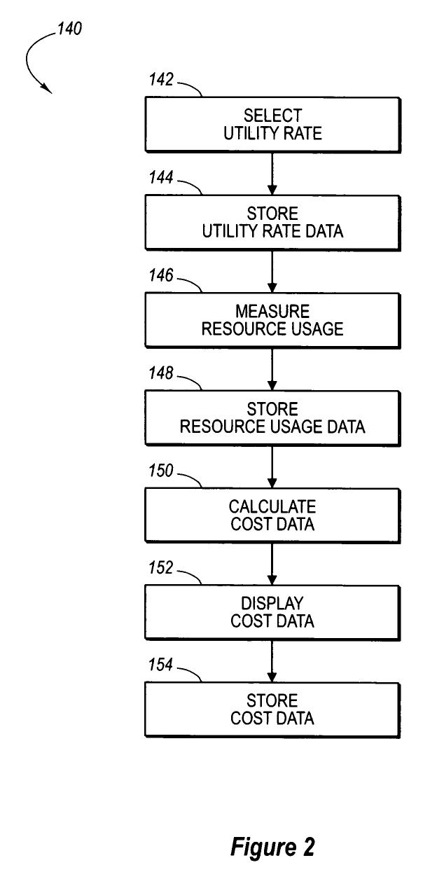

With attention now to FIG. 2, details are provided concerning aspects of an exemplary method 140 for tracking resource usage and capturing associated resource consumption costs. As shown in FIG. 2, at block 142, a utility rate may be selected. For example, in one embodiment, the resource meter 104 may be configured to receive user input indicative of a utility cost rate. Thus, a user may select a particular utility rate for an associated resource using device and/or an associated resource provider. The utility rate may indicate a cost per unit of resource consumed or otherwise used.

For example, the utility rate could comprise a cost per kilowatt hour of electricity, a cost per gallon of water, a cost per therm for natural gas, or any other suitable unit of measurement for any type of resource. If desired, the utility rate could indicate a flat cost for using a resource. In one embodiment, a variety of utility rates may be selected for an associated resource using device and/or an associated resource provider. Advantageously, the variety of utility rates may correspond to various volume thresholds or tiers, so as to allow for different cost rates for different volumes or tiers of resource usage. In one embodiment, the display 168 may display one or more utility rates, one or more of which may be selected by a user using the buttons 110 and 112 or any other suitable input device. Of course, a utility rate may be selected and/or determined in any other suitable manner.

As shown in FIG. 2, at block 144, the utility rate may be stored in a storage device. For example, in one embodiment, the measurement module 120 of the resource meter 104 may receive data indicating one or more utility rates for an associated resource using device and/or an associated resource provider. The measurement module 120 may store the received data in the storage device 124.

As illustrated in FIG. 2, at block 146, resource usage may be measured and resource usage information is stored, at block 148. For example, in one embodiment, the measurement module 120 of the resource meter 104 may measure the resource provided by the resource provider, 106, the resources used by resource using device 102, or both. Among other things, this functionality permits the user to identify leaks or other losses of resources. Additionally, the measurement module 120 may store data indicating the resource provided, the resource used, or both in the storage device 124. Of course, resource usage may be measured and/or stored by any other suitable component in any other suitable manner.

As shown in FIG. 2, at block 150, cost data such as the cost associated with measured resource usage, may be calculated. For example, in one embodiment, the measurement module 120 of the resource meter 104 may access the utility rate data, access the usage data, and may calculate a cost associated with that usage using the utility rate data, the usage data, or both. In one embodiment, the resource meter 104 may be configured to receive user input identifying one or more periods of time for which usage measurement and/or cost calculation should be performed. Accordingly, if desired, at the block 150, the measurement module 120 could measure resource usage, or calculate an associated cost, for the past hour, for the past month, for the past year, for the period since measurement began, or any other suitable period of time.

As shown in FIG. 2, at block 152, cost data may be displayed. For example, in one embodiment, the measurement module 120 of the resource meter 104 may display, using the display 108 (see FIG. 1A), some or all of the cost data that was calculated at the block 150. Of course, cost data need not be displayed, but, if displayed, could be displayed in any other suitable fashion using any other suitable device.

As shown in FIG. 2, at block 154, cost data may be stored. For example, in one embodiment, the measurement module 120 of the resource meter 104 may store, in the storage device 124, some or all of the cost data that was calculated at the block 150. Of course, cost data need not be stored, but, if stored, could be stored in any other suitable fashion using any other suitable device.

As shown in FIG. 1A, the resource meter may be configured to reset the measured resource usage data that is used for calculating the cost data. For example, the user may select the reset button 118, which may advantageously erase some or all of the usage data, utility cost data, or both. Of course, one skilled in the art will appreciate that the reset button 118; is optional and is not required by the resource meter 104.

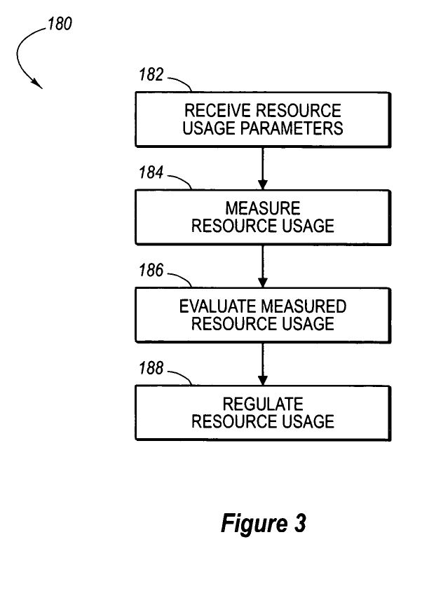

With attention now to FIG. 3, details are provided concerning aspects of an exemplary method 180 for tracking and managing resource usage. As shown in FIG. 3, at block 182, one or more values for one or more resource usage parameters are received. For example, in one embodiment, the resource distribution module 122 of the resource meter 104 receives one or more values for one or more resource usage parameters. For example, a resource usage parameter may indicate a threshold amount resource usage, a threshold cost for resource usage, any amount of resource usage, or any cost for resource usage; and a resource usage parameter may comprise any other suitable parameter. The resource distribution module 122 could receive the resource usage parameters via user input or from any other suitable method or system. More generally, resource usage parameters, as that term is used herein, embrace any characteristic pertaining to a particular resource, or consumption, use or management of that resource.

As shown in FIG. 3, at block 184, resource usage may be measured. For example, in one embodiment, the measurement module 120 of the resource meter 104 may measure the resource provided by the resource provider 106, the resources used by resource using device 102, or both. Of course, resource usage may be measured by any other suitable component in any other suitable manner.

As shown in FIG. 3, at block 186, the measured resource usage may be evaluated. For example, in one embodiment, at the block 186, the resource distribution module 122 of the resource meter 104 may evaluate the measured resource usage in view of one or more resource usage parameters, such as those received and/or obtained at block 182 for example, and the resource distribution module 122 may, at block 188, regulate the resource usage according to at least one of the one or more parameters.

For example, in one exemplary embodiment of the invention, the resource meter 104 evaluates the measured resource usage to determine whether the resource using device 102 has used a resource in an amount that meets and/or exceeds a threshold indicated by one or more parameters. In one embodiment, the resource meter 104 may regulate resource usage by sending a message via the resource distribution module 122 of the resource meter 104 to the resource distribution module 126 of the resource provider 106. In this example, the message either causes or directs the resource provider 106 to terminate providing resource to the resource using device 102.

In one exemplary embodiment, a resource being used by the resource using device 102 may is provided via the resource meter 104. Accordingly, the resource meter 104, responsive to determining that the measured resource usage exceeds one or more resource usage parameters and/or in response to any other suitable factors, can terminate provision of the resource to the resource using device 102.

In one example of such functionality, the electricity may be regulated to an air conditioner after electricity usage by the air conditioner has reached a specific amount and/or cost in a preceding time period, such as an hour, in the past day, in the past month, since measurement began, or for any other suitable time period. In another example, the water provided to a sprinkler system may be regulated after its water usage has reached a specific amount and/or cost in the past hour, in the past day, in the past month, since measurement began, or for any other suitable time period. In yet another example, the natural gas provided to a natural gas fireplace may be regulated after its natural gas usage has reached a specific amount and/or cost in the past hour, in the past day, in the past month, since measurement began, or for any other suitable time period.

In one exemplary embodiment, when resource usage is at or below a specific amount and/or cost in a preceding time period, such as the past hour, in the past day, in the past month, since measurement began, or for any other suitable time period, the resource may be provided to a resource consuming device. In some embodiments, projections are made concerning how much longer the resource can be provided to the resource consuming device, based on a current rate of consumption and/or other considerations. Of course there may be a variety of other resource consuming devices which may be regulated using parameters indicating other suitable time periods, amounts of time, and any total or average amounts of usage and/or costs.

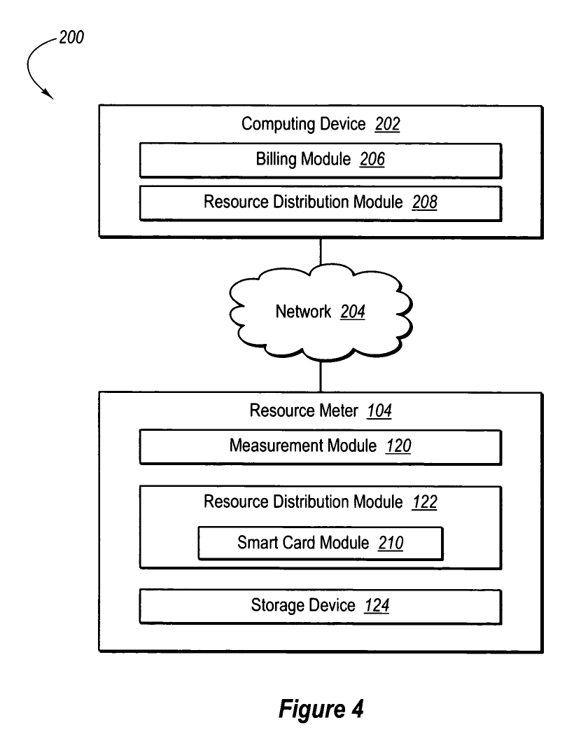

Directing attention now to FIG. 4, details are provided concerning aspects of an exemplary operating environment for systems, methods and devices of the invention. Particularly, resource management system 200 may include a computing device 202. As used herein, “computing device” is a broad term and is used in its ordinary meaning and includes, but is not limited to, hardwire and/or wireless devices such as personal computers, desktop computers, laptop computers, palmtop computers, a general purpose computer, a special purpose computer, mobile telephones, personal digital assistants (PDAs), Internet terminals, multi-processor systems, hand-held computing devices, portable computing devices, microprocessor-based consumer electronics, programmable consumer electronics, network PCs, minicomputers, mainframe computers, computing devices that may generate data, computing devices that may have the need for storing data, computing devices that may have the need for generating data, and the like. In one embodiment, the computing device 202 comprises a server, but may be implemented in other ways as well. Also, as shown in FIG. 4, the exemplary computing device 202 includes a billing module 206 and a distribution module 208. Additional or alternative components and modules may be incorporated in computing device 202 as well.

As shown in FIG. 4, the resource management system 200 may include one or more networks, such as a network 204. The network 204 may comprise of a local area network, a plurality of linked local area networks, a WAN, the Internet, any other network, any other connection, or any combination thereof. The network 204 may be implemented using one or more wired connections, one or more wireless connections, or any suitable combination thereof. The network 204 may comprise a 10/100/1000 Ethernet network. The network 204 may comprise a power line network. The network 204 preferably comprises any network or communication platform with sufficient bandwidth and adequate latency. Of course, the network 204 could have any other suitable configuration or features. Further, the resource management system 200 does not require the network 204.

As shown in FIG. 4, the resource management system 200 may include one or more resource meters (such as, a resource meter 104), which could be configured as the resource meter 104 shown and described with reference to FIGS. 1A-3. For example, if desired, the resource meter 104 (FIG. 4) may include a measurement module 120, a resource distribution module 122, and a storage device 124. Also, the resource distribution module 122 of the resource meter 104 may include a smart card module 210.

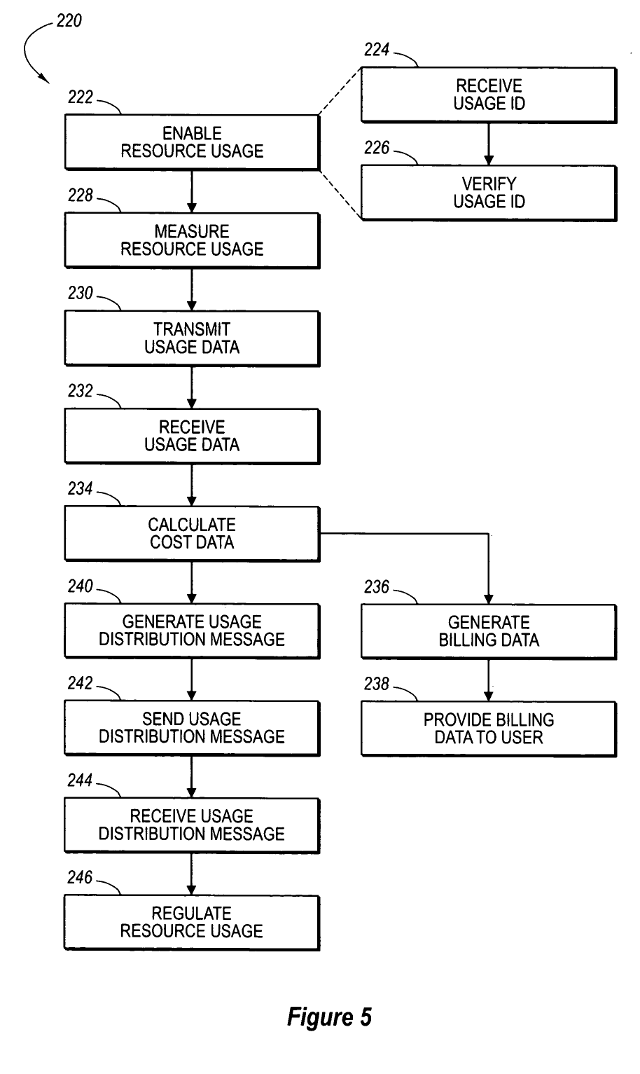

With reference finally to FIG. 5, details are provided concerning aspects of an exemplary method 220 for tracking and managing resource usage, as well as for performing related processes, such as billing for example. At block 222 of the method 220, the resource management system 200 may optionally enable resource usage. In one embodiment, the resource usage could be enabled using an identification system that may receive a usage I.D. at block 224, may verify the received usage I.D. at block 226, and may enable the resource usage upon the verification. In one embodiment, the smart card module 210 of the resource distribution module 122 may be adapted to provide a usage I.D. For example, the resource distribution module 126 of the resource provider 106 (see FIG. 1B) may be configured to verify the resource meter 104 using smart-card technology, sim-card technology, or any other suitable verification system. Advantageously, this may enable the resource distribution module 126 of the resource provider 106 to provide various resources upon verifying the resource meter 104.

If desired, the resource meter 104 could then provide cost data to various resource providers. In one embodiment, smart-card electricity measuring could be used for public libraries, airports, hotels, parks, recreational vehicle parks, or the like. In one embodiment, smart-card water measuring examples could be used for recreational vehicle parks, parks, hotels, or the like. Of course, any of a variety of other verification systems may be used in any suitable context for any resource.

As shown in FIG. 5, at block 228, resource usage may be measured. For example, in one embodiment, the measurement module 120 of the resource meter 104 may measure the resource provided by a resource provider, the resources used by a resource using device, or both. Of course, resource usage may be measured by any other suitable component in any other suitable manner.

With continued attention to FIG. 5, at block 230, the measurement module 120 of the resource meter 104 may transmit, via the network 204, usage data to the computing device 202. At the block 232, the billing module 206 of the computing device 202 may receive the usage data and may, at the block 234, calculate cost data associated with the usage data. In one embodiment, the measurement module 120 of the resource meter 104 may measure resource usage data, may calculate the associated cost data, and may transmit the usage data, the cost data, or both, via the network 204 to the computing device 202.

At block 236 of the method 220, the billing module 206 of the computing device 202 may generate billing data using the cost data and may, at the block 238, provide the billing data to the user in a suitable manner. The billing data may include, for example, an invoice for the resources used, historical consumption information, and projected consumption data.

With continuing reference to the exemplary method 220, the resource distribution module 208 of the computing device 202 may receive and/or use the cost data, the usage data, or both for evaluation in view of at least one of a set of one or more parameters. In response to this evaluation, the resource distribution module 208 may generate a usage distribution message at block 240 and may, at block 242, send the usage distribution message via the network 204 to the resource meter 104. The resource distribution module 122 of the resource meter 104 may receive the usage distribution message, at the block 144, and may regulate the resource usage accordingly at the block 246. For example, to regulate the resource usage, the resource meter 104 could terminate or enable the provision of a resource to the resource using device 102. Also, to regulate the resource usage, the resource meter 104 could send a message to the resource provider 106 and the resource distribution module 126 of the resource provider 106 could receive the message and could terminate or enable the provision of a resource to the resource using device 102.

In one exemplary embodiment, the resource using device 102 may comprise the resource meter. Advantageously, the resource using device 102 could then provide some or all of any functionality that the resource meter 104 may provide. Moreover, the resource meter 104 may, in some cases at least, be connected to a computer and may be configured to send a soft shut down command to the computer before switching off power to the computer.

Some embodiments of the resource meter 104 are configured to receive external, removable media, examples of which include, but are not limited to, a USB memory sticks, floppy disks, and portable optical media. If desired, the resource meter 104 may be configured to transfer usage data, cost data, or any other data from the storage device 124 to the external, removable media.

It will be appreciated that a resource meter may be configured to measure, store, and/or transfer the amount of resource provided by one or more resource providers, the amount of resource used by one or more resource using devices, or both. Further, the resource meter may be configured to display, calculate, and/or transfer cost data for any measured resource usage. Accordingly, a resource meter may be configured for measuring the electricity usage of, and/or distributing electricity to, refrigerators and freezers, HVAC systems, microwave ovens, computers, televisions, lights or lighting systems, circuit breakers, the entire premises of a location, such as a home or other building, other audio visual equipment such as stereos, VCRs, DVD players or the like, or any other suitable electricity using system.

Similarly, a resource meter could be configured for measuring the water usage of, and/or distributing water to, a sprinkler system, one or more sinks, one or more showers or bathtubs, one or more bathrooms, a washing machine, a pool, the entire premises of a location, or any other suitable water using system. Likewise, a resource meter could be configured for measuring the natural gas usage of, and/or distributing natural gas to, the entire premises of a location, one or more gas heaters, one or more air heaters, one or more water heaters, one or more stoves, one or more clothes dryers, one or more fireplaces, one or more barbecues, or the like.

Of course, a resource meter could be configured to measure the resource usage of and/or distribute resources to any one or more selected resource using devices that may use one or more resources. Indeed, it will be appreciated that a resource using device could use a plurality of various resources, one or more which may be measured, or otherwise monitored, and/or regulated by a resource meter.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for managing usage of a resource by at least one resource-using device, comprising:
obtaining resource cost information representing a per unit cost of a resource;
storing the resource cost information;
measuring an amount of the resource used by the at least one resource-using device over a predetermined period of time;
using the cost information and the measured amount of the resource to calculate a resource consumption cost associated with the at least one resource-using device; and
providing output to a user representing the calculated resource consumption cost.

2. The method of claim 1, wherein the resource comprises at least one of: water; steam; gasoline; cable television; satellite television; bandwidth; telecommunications; radio; short distance telephone service; long distance telephone service; Internet service; mobile telephone service; electrical or optical digital data service; and, satellite service.

3. The method of claim 1, further comprising regulating the amount of the resource consumed by the resource-using device.

4. The method of claim 1, further comprising using consumption cost information to regulate the amount of the resource consumed by the resource-using device.

5. The method of claim 1, further comprising generating billing data concerning the amount of the resource consumed by the at least one resource-using device.

6. The method of claim 1, further comprising enabling usage of the resource by the resource-using device upon satisfaction of predetermined criteria.

7. The method of claim 1, wherein the method is performed in connection with each of a plurality of resource-using devices.

8. A resource meter for use in connection with the management of resource consumption by at least one resource-using device, the resource meter comprising:
a resource interface configured to detect a flow of a resource associated with the at least one resource-using device;
a measurement module in communication with the interface and configured to measure an amount of resource used by the at least one resource-using device and configured to display the amount of resource used by the at least one resource-using device;
a resource distribution module configured to regulate resource usage of the at least one resource-using device; and
a storage device in communication with the measurement module and the resource distribution module.

9. The resource meter as recited in claim 8, wherein the resource meter is configured to be integrated within a resource-using device.

10. The resource meter as recited in claim 8, wherein the resource meter is portable.

11. The resource meter as recited in claim 8, wherein the resource interface comprises at least one sensor.

12. The resource meter as recited in claim 8, wherein the resource meter further comprises provider interface for connection with a resource provider, the provider interface being in communication with at least the resource distribution module.

13. The resource meter as recited in claim 8, wherein the resource meter further comprises:
a four button primary user input interface that comprises: a + button; a − button; and, a mode button;
an integrated Ground Fault Interrupter (GFI) circuit and switches; and
a master reset.

14. The resource meter as recited in claim 8, wherein the resource meter is configured for use with at least one of: water; steam; gasoline; cable television; satellite television; bandwidth; telecommunications; radio; short distance telephone service; long distance telephone service; Internet service; mobile telephone service; electrical or optical digital data service; and, satellite service.

15. The resource meter as recited in claim 8, wherein the resource meter is configured to transfer data from the storage device to external media.

16. The resource meter as recited in claim 8, wherein the resource distribution module of the resource meter is configured to regulate resource usage responsive, at least in part, to a measured amount of resource used by the at least one resource using device.

17. A resource management system, comprising:
at least one resource meter associated with a corresponding resource-using device; and
a computing device configured for communication with the at least one resource meter by way of a network.

18. The resource management system as recited in claim 17, wherein the computing device includes at least one of: a billing module; and, a resource distribution module.

19. The resource management system as recited in claim 17, wherein the at least one resource meter comprises:
a resource interface configured to detect a flow of a resource associated with the resource-using device;
a measurement module in communication with the interface and configured to measure an amount of resource used by the resource-using device and configured to display the amount of resource used by the resource-using device;
a resource distribution module configured to regulate resource usage of the resource-using device; and
a storage device in communication with the measurement module and the resource distribution module.

20. The resource management system as recited in claim 17, wherein the computing device comprises a server.
